(19) United States
(12) Patent Application Publication
(10) Pub. No.: US 2018/0144519 A1
(43) Pub. Date: May 24, 2018

(54) Event Digital Image Enhancement

(71) Applicant: Alpha Event Marketing Services Inc., Houston, TX (US)

(72) Inventors: Richard Didow, Houston, TX (US); Robert Bryant, Houston, TX (US)

(73) Assignee: Alpha Event Marketing Services, Inc., Houston, TX (US)

(21) Appl. No.: 15/356,617

(22) Filed: Nov. 20, 2016

(51) Int. Cl. G06T 11/60; G06T 1/00

(52) U.S. Cl. CPC G06T 11/60; G06T 2210/61; G06T 1/0007

(57) ABSTRACT

Enhancing digital photo images (digital photo image) with the identity of persons within the digital photo image, the digital photo image location or subject matter, the identity of an event sponsor or event location such as a sports facility or music event or slogan or logo. The digital photo image may be a still digital photo image or a video. The camera may be incorporated into devices including but not limited to a phone, tablet, eyeglass or watch. The enhanced digital photo image can be accessed by the user, preferably within minutes. The user may supply information to the media editor such as user's name, names of individual in the image, the users email address. The media editor may return a bar code image via MMS to facilitate the user collecting of the image.

### RELATED APPLICATION

The Applicant incorporates herein by reference in its entirety the contents of Provisional Application 62/187,448 filed Jul. 1, 2015 and entitled “Event Digital Image Enhancement.”

### FIELD OF USE

The use of smart telephones containing one or more cameras capable of making digital images are combined with the digital transmission features of the smart phones, allowing the pictures to be transmitted nearly anywhere.

### PRIOR ART

Digital images edited with green screen effects are known. In this procedure, a digital image is taken of a subject in front of a green screen. A different background can be substituted. The substituted background may provide the location or event at which the digital photo image was taken. Characters or individuals can be interposed in the picture. The digital photo image subject may retrieve the physical digital photo image or retrieve the digital image digitally from an Internet site.

Also known in the art is a person taking a digital photo image and sending the digital photo image to a website. The website provides options to the user for enhancement to the digital photo image. The user chosen enhancements are then saved to the enhanced digital image and the enhanced digital image is made available to the user to retrieve.

Also known art is a person taking a digital photo image and then selecting predetermined special effects and the digital photo image is immediately enhanced and is visually available on the device in which the digital photo image was taken. The user can continue to change the enhancements or approve the digital photo image. The selected enhanced digital photo image is made available to the user to retrieve.

### BRIEF SUMMARY OF THE DISCLOSURE

The Applicant's disclosure differs from the prior art in several ways. For example, the disclosure differs from the prior art in that the enhancements are not decided by the user but rather are predetermined by a third party and the process of enhancement is done automatically without user intervention. The enhanced digital images are then made available to the user to retrieve.

The disclosure includes the utilization of cameras frequently installed on smart telephones or tablets. A tablet may contain many of the features of a smart phone as described in the following paragraph.

A smart phone is a mobile phone (also known as a cell phone) with an advanced mobile operating system that combines features of a personal computer operating system with other features for mobile or handheld use. Smart phones, which are usually pocket-sized, typically combine the features of a mobile phone, such as the abilities to place and receive voice calls and create and receive text messages, with those of other popular digital mobile devices like personal digital assistants (PDAs), such as an event calendar, media player, video games, GPS navigation, digital camera and digital video camera. Most smart phones can access the Internet and can run a variety of third-party software components (“apps”). They typically have a color display with a graphical user interface that covers 70% or more of the front surface. The display is often a touchscreen, which enables the user to use a virtual keyboard to type words and numbers and press onscreen icons to activate “app” features.

The digital images may be generated by other devices such as computers, tablets, glasses or watches. Any device containing a camera and electronic data transmission capability, e.g. WIFI, may be subject of this disclosure. This disclosure also applies to digital video images. All of these devices will hereinafter be termed “phones”. The smart phones and tablets contain microprocessor or computer processing units (CPU). This allows the phone to contain multiple features previously unavailable to mobile telephones.

The camera is one example. The telephone's ability to be integrated to WIFI networks and the Internet is another example.

Use of the phone camera is one of the most popular features of the phones. The user is able to take a digital image of almost any subject and upload the digital photo image to a personal computer, a social media site, store the digital photo image on the camera memory for later retrieval, etc.

This disclosure has many novel facets. One is for the user to upload or electronically transmit the digital image to a specified server or similar device, wherein the digital image can be enhanced by additions automatically made by the server, including the date, the time of day, etc. (It will be appreciated that a server is a component of computer hardware that may operate functional software for other programs or devices. This may involve sharing of data or resources and performing computations or functions of a client, e.g., an event sponsor. It can include a database server, print servers, web servers and application servicers.) The enhancement to the digital images subject of this disclosure could also include branding from sponsors, i.e., third party presenting an event, event facility, social activity or promotion. The server can be controlled or operated by a third party. As used herein, the server includes components or ancillary devices that permit the copying or alteration of the user's uploaded electronic image. This can be a media editor as described in the following paragraph. This can also include transmission of the altered electronic images. This could include transmission back to the user's device, e.g., smart phone, or to a social media site.

Branding could be the placement of the sponsor's name, logo or slogans. Branding could also include pictures of persons that the user would like to have included, e.g., a spokesperson or third party image for the sponsor. Also included in the disclosure is the addition of video content that would be embedded within the user's video submitted to the media editor. (The media editor, hereinafter “media editor” may be the service or facility, e.g. server, that enhances the user digital images (and videos) transmitted electronically). It will be appreciated that the media editor can simultaneously enhance digital images from several sources or from different functions, e.g., a sports event and a wedding or store promotion. These can be completely different occasion occurring simultaneously, e.g., two or three weddings.

Enhancements are additions to the user's digital image, Enhancements can include additions of elements of branding as discussed above, e.g. event name, sponsor identity, date, etc. As used in this disclosure, enhancement could include comprehensive re-digitization a digital image or magnification of a portion of the image. Enhancement may include removing “red-eye”. It may also include altering the lighting or color of the image to enhance image clarity. The enhancement may also include the additions of one or more filters to the image. The image may be converted to black and white or sepia tone. In some embodiments, the disclosure may alter the image by cropping.

If entered by the user, the digital image may be labeled with the subject of the digital image. Similarly, if the digital photo image contains individuals, the user can provide the identity of the subjects on the digital photo image. This may be information transmitted to the media editor at the time the digital image is transmitted. The media editor site may prompt the user to supply this type of information. As stated, this may require the user to text the information to the media editor or require the user to upload this information to the media editor's site in addition to uploading the digital photo image to the site.

It will be appreciated that when uploading the digital photo image to the site for editing/enhancement, the user would also provide their name and mobile telephone number. This information may be provided to the site automatically as part of the uploading process. The user's name may be separately texted to the media editor. The user may also provide one or more email addresses.

In one embodiment, the information provided by the user may be aggregated. This information may be supplied to the sponsor or event facility for future use. This use may include future offers or event announcements. This information could be supplied to third parties. Use could include marketing or survey functions.

In one embodiment, the media editor server (which can be located at the event site or at a remote location) can return the digital photo image to the user digitally using, for example, MMS. Alternatively the media editor site can post the digital photo image at an Internet or social media site for retrieval by the user, etc. as will be explained in greater detail below. This disclosure is not limited by the method or technology utilized to convey the digital image.

### DETAIL DESCRIPTION OF DRAWINGS

The accompanying drawings, which are incorporated in and constitute a part of the specification, illustrate preferred embodiments of the disclosure. These drawings, together with the general description of the disclosure given above and the detailed description of the preferred embodiments given below, serve to explain the principles of the disclosure.

FIG. 1 Illustrated a flow diagram showing one example of the steps of the disclosure. FIG. 1 illustrates the steps of photo capture (101), transfer via MMS to a photo enhancement site (102), followed by creation of an enhancement to the photo image (104) and transmission of the enhanced photo (105) via MMS (108). The enhanced photo image (digital image) can be sent to a microsite containing a survey or sharing of the digital image with social media (109). Alternatively, the photo can be sent to a display medium (monitor or jumbo-tron) (110), link to a microsite (111), photo sent to user (112), digital image sent directly to social media (113), photo to printing or retrieval station (114) or the digital image can be sent to sponsor or third party site (115).

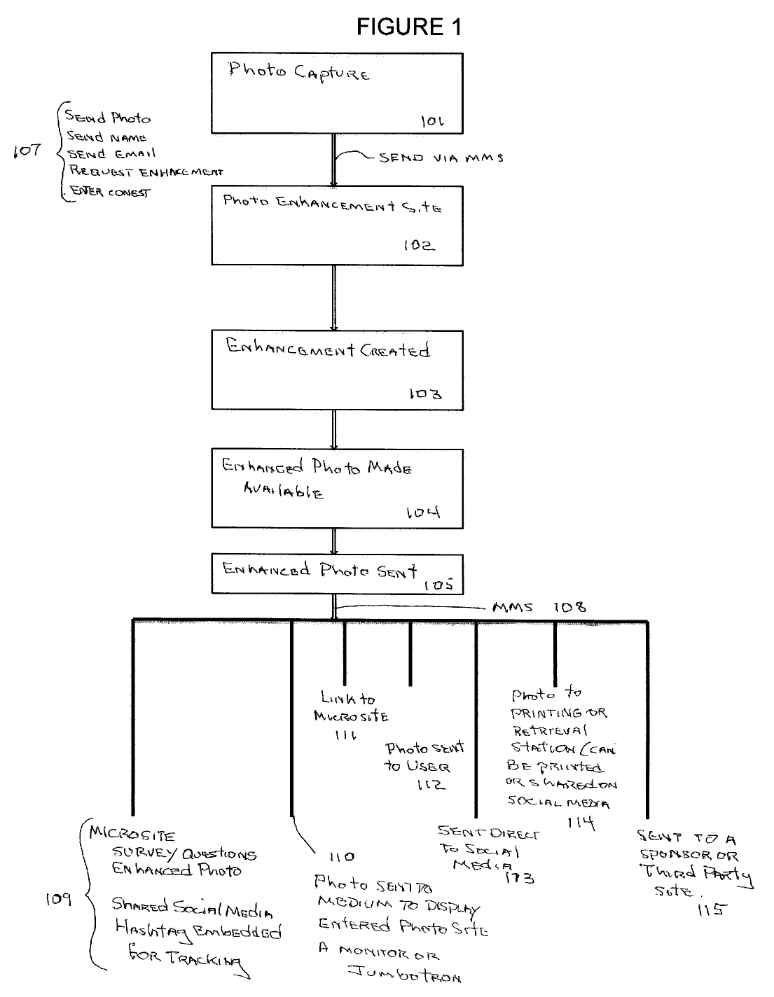

### DETAILED DESCRIPTION OF THE DISCLOSURE

The novel process of the disclosure may use existing electronic components such a smart phones, tablets, computers, watches, digital cameras with WIFI capability, WIFI, Internet, digital processing, websites and social media sites. The novel procedure may be adapted to further develop or enhance electronic components such a labeling or posting the names of the subjects appearing the digital photo image or scenes shown in the digital photo images. It will be appreciated that the term digital photo image as used in this disclosure includes videos taken by the phones. Digital photo images (including videos) are also referred to as “digital image”.

The disclosure utilizes the term media editor. It will be appreciated that the media editor may comprise an automated and programmable digital image processor (“media processor). The media processor may be a server capable of making enhancement to multiple digital images for one or more events, social functions, promotions or the like. The server is structured to receive digital images submitted via WIFI (a local area wireless computer networking technology) or MMS (multi-media messaging service) or similar technology. The server receives the device address and/or the telephone number of the device submitting the digital image. This information can be stored in memory.

In one embodiment the media processor enhances the digital image in various ways. In one embodiment the media processor adds pre-selected content information. This content can be selected by the management of the event location, selected by the event sponsor, or store promoter. The digital image enhancement service can be also used by planners of a social gathering such as a wedding, birthday party or political campaign event. The processor is programmed to insert the preselected content information on the digital photo image. The media processor program may control the addition of the information to a location proximate to an edge of the image. This program function will minimize the interference or obstruction of the digital photo image. After placement of the content, the enhanced digital image can be returned or information provided to allow user access to the image.

In another embodiment, the server may utilize software that allows the server to distinguish between individuals in the foreground of the digital image and subject matter in the background. As discussed herein, the user may exercise an option at the time of submission of digital image to the server, to have a third party inserted into the image. The third party may be inserted in the foreground or background of the image.

In another embodiment, after the digital image is received by the processor, the processor may send a message to the user. The message can be a text message or it may be a form with questions. In one embodiment, the processor can provide an opportunity to the user to identify persons appearing in the image. The user may identify the subject of the digital image. The user can type in the information using the key pad on its smart phone or tablet. The responses will be readable or automatically processed by the processor. In another embodiment, the processor can solicit whether the user wants to have the enhanced image posted on a website, such as the individual user's web page, social media site or similar. The processor may solicit whether the user want to “tag” any of the individuals in the photo using the social media. Social media may be computer-mediated technologies that allow the creating and sharing of information, ideas, career interest and other forms of expressions via virtual communities and networks. Some common features of social media include user-generated content such as text posts or comments, digital photos or videos, as well as data generated through all online interactions, user created service-specific profiles for the website or app that may be designed or maintained by a social media organization and social media facilitating the development of online social networks by connecting a user's profile with those of other individuals or groups.

At this time, the processor may solicit information from the user such as email address, names of persons in the digital image, subject matter of the digital image, any text to be added to the digital photo image, etc. The processor may at this time request other information from the user, including interest in taking a survey or entering a contest. In one embodiment, these solicitations may be optional.

In one embodiment, the enhancement, both pre-selected and that requested by the user through the two way communication with the processor will be handled in real time, i.e., the information will be processed and the digital photo image will be enhanced as the image and any supplemental information is received.

In yet another embodiment, the there may be a “re-do” option. For example, if the user discovers upon receipt of the enhanced digital photo image that a name or word has been misspelled, the processor will have provided the user with information to allow the user to communicate the error to the processor and the error corrected by submission of a replacement digital photo image.

The method or process of this disclosure starts with the user taking a digital image. The digital photo image may be of a scene, i.e., a physical location including a physical location as the background of the digital photo image. The digital image may be of people. The people can be facing the camera.

The digital image can contain the user. The user alone may be the subject or image in the digital image or the digital image may include a group of other people. (These digital images are sometimes referred to as “selfies”).

The digital image can be taken at an event site such as a sporting event, a musical event or other social event including private events, e.g., a wedding or anniversary. It will be appreciated that the user or event planner can select the style of the editing or placement of the event or participant identification. This information can be selected in advance by the event or function planner. The user can upload the digital image and supplemental information to a media editor using text messaging such as MMS. The specific event can be identified by the media editor by a code utilized by the user at the time the digital photo images are uploaded. This may be a short code. Again the user may input the user's name, cell phone number or email address. This may facilitate the media editor returning the enhanced digital photo images to the user.

It will be further appreciated that the editing process (enhancing) can be performed rapidly so that the enhanced digital image can be uploaded to the user's phone during the duration of the event. This can enhance the enjoyment of the digital photo images to the user.

Regardless of the subject matter or location of the digital image, the digital image can be electronically uploaded to a media editor. The media editor (processor or server) may be at the event location or at a remote location.

As discussed above, the location can be a public or private event. A public event may be a sporting event. The digital image editing service may be sponsored. It does not, in fact, have to be event for the user to use this method or process. It can be a stand alone or independent service.

The digital image editing can be simply identification of the location. The enhancement (enhancing) can provide the date and the teams participating in the digital image event. The information can be stylized, perhaps incorporating a trademarked logo or name of the event location or the sponsor. As indicated, the enhancement by the media editor may include the identity of the event sponsor. The digital image enhancement may be aesthetically pleasing art work or design, perhaps related to the theme of the event.

In another embodiment of the enhancing process, the user may communicate to the server that the user wants to include a third party i.e., sports figure or politician, within the enhanced digital image. The user may select among one of several third parties. Each selection may have its own boarder. In a further embodiment, the user may have multiple choices to be the subject matter of the enhancement, i.e., the sponsor may have two or more events or social gatherings. For example, the user may be attending a music or arts festival that has multiple separate venues. The user, for example may select, at the time the digital image is transmitted to the server, the venue the user wishes to have featured in the enhancement. The user may also optionally select which event, occasion or team or team player that desired by the user to be added to the digital image. This selection would be made at the time the digital image was transmitted to the server. For example, if the user is at a sporting event with two competing teams, the user may select a player from one of the competing teams. The enhancement may automatically include the identity and/or slogan of the team as well as the identity of the player. The enhancement made by the server could position the player (third party) either in front or background.

It will be appreciated that the user or event planner does not require the phone to download mobile application software, i.e., an “app” designed to run on smart phones, tablets, laptops or desktop computers. This makes the service subject of this disclosure readily available to all persons possessing phones (as defined herein).

The enhanced digital images can be uploaded to the user's phone using the phone number provided to the user or other identifier of the user's device, e.g., IP address. The enhanced digital image can be accessed by the user, preferably within minutes. This prompt return to the user's device may enhance the user's enjoyment of the service provided by the media editor or sponsor. In another embodiment (where the media editor is located at the location of the event) the printed enhanced digital images can be collected at one or more locations at the event location. The user may electronically receive an identification or collection code from the media editor when the user's digital photo images are initially uploaded to the media editor's processor or server. The media editor may return a bar code image via MMS to facilitate the user collecting of the image.

This identification number or code can be used to pickup the digital photo images. As an alternative, the user may receive a 1D or 2D bar code or QR code that can be read at the media editor's collection site.

In yet another embodiment, the media editor can be placed a different location. The enhanced digital images can be transmitted back to the event site where the digital photo images are printed. The user can collect at the printing location using the code mechanism transmitted to the user.

The enhanced photo image (digital image) can be sent to a microsite containing a survey or sharing of the digital image with social media. Alternatively, the digital image can be sent to a display medium (monitor or jumbo-tron), link to a microsite, sent (electronically retransmitted) to the user, digital image sent directly to social media, e.g., the user's provided social media address, providing the digital image to a printing or retrieval station or the digital image can be sent to the sponsor's or third party site for promotional display. It will also be appreciated that the user supplied information (inputted or automatically transmitted such as the IP address of the smart phone or tablet) can be retained by the sponsor or third party. The third party may be acting as an agent or service provider on behalf of the sponsor.

The submission of a digital image by the user could allow the user to be a participant of a contest. This could be a contest or lottery implemented or operated by a sponsor, e.g., car manufacturer, etc. This may induce the user to convey additional information when submitting his/her digital photo image to the media editor. This information could have additional benefit to the sponsor in future contact with the user, e.g., other promotions. In another embodiment, the winner of the contest could be announced during or at the conclusion of the event. In another embodiment, the contest could be conducted after the event and after the digital image has been returned to the user from the media editor.

In another embodiment, the user would receive the enhanced digital image from an Internet site or similar. The enhanced digital photo image could be accessed after the user answers survey questions. In another embodiment, the enhanced digital photo image could be returned and then the user asked to answer survey questions.

In another embodiment, the actions of the sponsor or media editor could post the enhanced digital photo image on one or more of the user's social media site. This could include the social media sites of the participant's of the digital image. Again this step would require the user to have conveyed the necessary information to either the sponsor or media editor.

In yet another embodiment, one or more enhanced digital images could be submitted to the sponsor's site, including one or more social media sites. In another embodiment, if the enhanced digital image is retrieved from a website, a hash-tag can be embedded with the digital image. When the user posts the enhanced digital image, it will carry the hash tag with it. The number of hash tags appearing the Internet, e.g., social media sites, can be audited or monitored to see how many people are sharing the digital images with others. It will be recalled that the enhanced digital images may contain sponsor or event location identifiers.

In another embodiment where the venue is a large sporting event or musical concert, selected enhanced digital photo images may be displayed on image display equipment located at the site venue.

This specification is to be construed as illustrative only and is for the purpose of teaching those skilled in the art the manner of carrying out the disclosure. It is to be understood that the forms of the disclosure herein shown and described are to be taken as the presently preferred embodiments. As already stated, various changes may be made in the shape, size and arrangement of components or adjustments made in the steps of the method without departing from the scope of this disclosure. For example, equivalent elements may be substituted for those illustrated and described herein and certain features of the disclosure maybe utilized independently of the use of other features, all as would be apparent to one skilled in the art after having the benefit of this description of the disclosure.

While specific embodiments have been illustrated and described, numerous modifications are possible without departing from the spirit of the disclosure, and the scope of protection is only limited by the scope of the accompanying claims.

1. A method for digital enhancement of user created digital photo images comprising:
a) creating the digital photo image;
b) transmitting electronically the digital photo image to a media editor;
c) enhancing the digital photo image by the media editor;
d) causing the enhanced digital photo image to be accessible to the user.

2. The method of claim 1 further comprising the digital photo image by adding at least one of a group comprising the identity of a digital photo image location, one or more subjects in the digital photo image, the sponsor of an event related to the digital photo image, logo, slogan, added third party image or preselected artwork.

3. The method of claim 2 further comprising posting the enhanced digital photo image on a social media site.

4. A method for digital enhancement of a user created digital photo image comprising:
a) receiving a digital photo image from a user through an Internet, email, MMS, or WIFI connection wherein contact information for the user is included;
b) enhancing the digital photo image; and
c) submitting the digital photo image for access by the user.

5. The method of claim 4 further comprising
a) the media editor receiving information regarding the contents shown on the digital photo image; and
b) the media editor utilizing all or some of the information in the enhancement of the digital photo image.

6. A system for remote editing of digital images wherein selected information can be added to the digital images comprising:
a) server containing components for electronic receipt of a digital image and information; and
b) the server components enhancing the digital image utilizing programmed information or electronically transmitted information.

7. The system of claim 6 further comprising:
a) a receiver device for receiving digital signals that can be compiled into an image;
b) a receiver for receiving user supplied information; and
c) program for enhancing the compiled image utilizing program data or user supplied information.

8. The system of claim 7 wherein the program enhances the compiled image to add information including at least one of the date, time, event, event location, sponsor, image subject
